(19) United States
(12) Patent Application Publication
(10) Pub. No.: US 2008/0075075 A1
(43) Pub. Date: Mar. 27, 2008

(54) Method for Establishing a Multimedia Connection

(76) Inventor: Klaus Hoffmann, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/662,005

(22) PCT Filed: Sep. 28, 2005
(86) PCT No.: PCT/EP05/54890

§ 371 Date: Mar. 6, 2007

(30) Foreign Application Priority Data
Sep. 28, 2004 (DE) 10 2004 047 027.8

(51) Int. Cl. H04L 12/56

(52) U.S. Cl. 370/389

(57) ABSTRACT

In one aspect a method for establishing a multimedia connection between at least one calling user and at least one called user via packet-oriented computer networks is provided. The call is established via at least one additional user while the at least one called user signals his state to the at least one additional user. The at least one additional user signals the state of the called user to the calling user, the state being preferably signaled by means of SIP signaling messages. The called user uses the signaling message “Ringing” while the additional user uses the signaling message “Session Progress”.

### CROSS REFERENCE TO RELATED APPLICATIONS

This application is the US National Stage of International Application No. PCT/EP2005/054890, filed Sep. 28, 2005 and claims the benefit thereof. The International Application claims the benefits of German application No. 102004047027.8 DE filed Sep. 28, 2004, both of the applications are incorporated by reference herein in their entirety.

### FIELD OF INVENTION

The invention relates to a method for establishing a multimedia connection.

### BACKGROUND OF INVENTION

In recent years, computer networks have developed to become an important communication medium via which a multiplicity of services are offered. The best-known computer network in the world is the Internet, this being the name given to the totality of all networks that are interconnected and use the Internet Protocol IP as a transport protocol.

The Internet Protocol IP at level 3 of the OSI layered model is responsible for the connectionless transport of data from a sender—possibly over a plurality of networks—to the recipient, providing neither error detection nor error correction.

Transport protocols such as the Transmission Control Protocol TCP or User Datagram Protocol UDP are situated above the Internet Protocol, and then above these comes an almost limitless multiplicity of different and sometimes competing application protocols such as http and FTP, for example, or (for the management of multimedia connections) the so-called SIP protocol or the ITU standard H.323.

With regard to multimedia connections in the Internet, there are currently two competing standards for signaling: H.323 and SIP. The ITU standard H.323 (ITU: International Telecommunication Union) was developed for the realtime transmission of multimedia applications such as voice and video communication in packet-oriented networks. As a so-called umbrella standard, it comprises a range of protocols for e.g. signaling, exchanging terminal functionalities and status information, and for connection control and data flow control. H.225, H.245 and H.450.x are among the most important protocols of the H.323 standard. H.225 describes signaling protocols such as RAS (Registration, Admission, Status) and call signaling. H.245 functions as a control protocol for multimedia communication. The H.450 standard defines additional telephony functions, in order to reproduce the performance features of ISDN on IP, for example.

For the case of a multimedia connection, wherein establishing the basic channel (also called bearer or bearer channel) and signaling (call) take place separately, the means whereby known services can be implemented are defined in parallel and alternatively by the ITU-T standard Q.1902.XBICC CS2 (bearer independent call control capability set 2) and Q.765.5 BAT (bearer application transport).

The Session Initiation Protocol SIP was developed by the IETF (Internet Engineering Task Force). The standard defines a signaling protocol for establishing, modifying and terminating sessions involving two or more subscribers. The Session Initiation Protocol SIP is also used for the transmission of realtime data over packet-based networks and is functionally comparable with the protocols defined in ITU standard H.323: the Session Initiation Protocol SIP can negotiate interactive communication services including voice over IP networks; the transport functions via TCP (Transmission Control Protocol) or UDP (User Datagram Protocol). In this case, the Session Initiation Protocol SIP is responsible for the voice signaling and for the localization and registration of users. In particular, however, it also allows the caller identity to be transferred and call forwarding in IP networks. The Session Initiation Protocol SIP is text-oriented, based on HTTP (Hypertext Transfer Protocol), and therefore offers an open Internet-based structure. Consequently, new performance features can be implemented relatively simply and quickly.

The two cited standards are continually being developed further. Recent examples include Q.1912.5 “Interworking SIP and BICC/ISUP” for ITU-T and RFC 3366 “SIP basic call flow examples” for IETF.

### SUMMARY OF INVENTION

Despite every effort on the part of standardization bodies, it is still not possible to reproduce all performance features of ISDN on connections via packet-switching computer networks without conflict.

The invention therefore addresses the problem of further developing multimedia connections in accordance with the cited standards.

According to the invention, this problem is solved by means of a method for establishing a multimedia connection over packet-switching computer networks between at least one calling subscriber and at least one called subscriber, wherein the call is established via at least one further subscriber and the at least one called subscriber signals its status to the at least one further subscriber and the at least one further subscriber signals the status of the called subscriber to the calling subscriber.

It is advantageous if at least the called subscriber and the further subscriber use the Session Initiation Protocol as a signaling protocol and if the further subscriber signals the status of the called subscriber to the calling subscriber by means of the signaling message 183 in accordance with the Session Initiation Protocol.

In this context, the term subscriber designates not just people but also automatic systems of all types, e.g. call answering systems and automatic application programs (applications) which can exchange multimedia messages.

In principle, any type of information transmission is conceivable as a multimedia connection in this context. Clearly, however, the transmission of voice, fax or data transmission via modem are particularly important.

### DETAILED DESCRIPTION OF INVENTION

The invention is explained in greater detail with reference to an exemplary embodiment.

The exemplary embodiment relates to the case of a call from a so-called A-subscriber to a further subscriber. However, the latter (the B-subscriber) has activated the performance feature “call forwarding”, such that the call is rerouted to a third subscriber, the so-called C-subscriber. All three subscribers are connected to a packet-switching computer network, and in this case can be so-called IP telephones, soft clients (programs on computers), or automatic systems of all types, e.g. call answering systems and automatic application programs (applications) which are capable of exchanging multimedia messages.

The subscribers use the Session Initiation Protocol or SIP-T etc. as a signaling protocol.

According to the prior art, the A-subscriber does not receive a ringing tone during such a sequence, since there is no rule for this case in the current standard.

According to the invention, when such a call is established, the C-subscriber signals the “ringing” status to the further rerouting B-subscriber by means of the signaling message 180 “Ringing” as per the Session Initiation Protocol.

In this case, the task of the B-subscriber can also include a proxy server such as e.g. a SIP “application server”.

The latter now uses the message 183 “Session Progress”, which per se serves to transmit information concerning the progress of the call establishment according to the Session Initiation Protocol, in order to signal to the calling A-subscriber, in accordance with the invention, that a ringing tone should be set.

In order to provide further clarification, a table showing an example of a call being established is included below, wherein the sequence initially starts with the forwarding operation:

| | Server of the B-subscriber | |
|---|---|---|
| A-subscriber | Re-router | C-subscriber (SIP) |
| | | −> INVITE |
| | | (establish call to the |
| | | C-subscriber) |
| Ringing tone | <− 183 (Session Progress) | <− 180 Ringing (without |
| is set up or | with Alert Info | SDP) (i.e. subscriber |
| window opens | | is called) |
| | Implement mapped or | With or without Alert |
| | default value | Info |
| Ringing tone | <− 183 (Session Progress) | <− 183 (Session Progress) |
| is switched | without Alert Info | without Alert Info |
| off or window | | |
| is closed | | |
| | or | |
| Ringing tone | <− 183 (Session Progress) | <− 183 (Session Progress) |
| is set up or | with Alert Info | (without SDP) with Alert |
| window opens | | Info |
| Ringing tone | <− 200 OK (with SDP) | <− 200 OK (with SDP) |
| is switched | | Subscriber has answered |
| off or window | | |
| is closed | | |

1.-6. (canceled)

7. A method for establishing a multimedia connection over packet-switching computer networks between a calling subscriber and a called subscriber, comprising:
establishing a call via a further subscriber;
signaling a status of the called subscriber to the at least one further subscriber by the called subscriber; and
signaling a status of the called subscriber to the calling subscriber by the further subscriber.

8. The method as claimed in claim 1, wherein a Session Initiation Protocol is used as a signaling protocol at least between the called subscriber and the further subscriber, and that the further subscriber signals the status of the called subscriber to the calling subscriber via a signaling message 183 in accordance with the Session Initiation Protocol.

9. The method as claimed in claim 7, wherein a voice connection is set up as a multimedia connection.

10. The method as claimed in claim 7, wherein a fax connection is set up as a multimedia connection.

11. The method as claimed in claim 7, wherein a data connection which is routed via a modem is set up as a multimedia connection.

12. The method as claimed in claim 7, wherein a video connection is set up as a multimedia connection.

13. A method for establishing a multimedia connection over packet-switching computer networks between a first subscriber and a third subscriber, comprising:
establishing between the first subscriber and the third subscriber via a second subscriber having a call forwarding feature, wherein the call forwarding feature setup to forward calls to the third subscriber;
providing a ringing status via a signaling protocol by the third subscriber to the second subscriber; and
providing a second status via the signaling protocol, the second status provided to the first subscriber by the second subscriber such that the first subscriber is notified of a ringing of the third subscriber.

14. The method as claimed in claim 13,
wherein the signaling protocol is based on a Session Initiation Protocol, and
wherein the second status is a signaling message 183 in accordance with the Session Initiation Protocol.

15. The method as claimed in claim 13, wherein a voice connection is set up as a multimedia connection.

16. The method as claimed in claim 13, wherein a fax connection is set up as a multimedia connection.

17. The method as claimed in claim 13, wherein a data connection which is routed via a modem is set up as a multimedia connection.

18. The method as claimed in claim 13, wherein a video connection is set up as a multimedia connection.
